(19) United States
(12) Patent Application Publication
(10) Pub. No.: US 2020/0380547 A1
(43) Pub. Date: Dec. 3, 2020

(54) SYSTEMS AND METHODS FOR QUANTIFYING FINANCIAL HEALTH IMPACT OF LIFE ACTIVITIES

(71) Applicant: Wells Fargo Bank, N.A., San Francisco, CA (US)

(72) Inventors: Dominik Vltavsky, Belmont, CA (US); Wayne Barakat, Novato, CA (US); David C. Hatch, Pacifica, CA (US)

(21) Appl. No.: 15/331,143

(22) Filed: Oct. 21, 2016

Related U.S. Application Data
(60) Provisional application No. 62/246,855, filed on Oct. 27, 2015.

(51) Int. Cl. G06Q 30/02; G06Q 20/40; G06Q 10/06

(52) U.S. Cl. CPC G06Q 30/0215; G06Q 10/067; G06Q 20/4016

(57) ABSTRACT

A computer-implemented method includes receiving financial activity information associated with a financial account of a user. The financial activity information relates to one or more financial activities of the user. Non-financial activity information relating to the user is received. The non-financial activity information relates to one or more non-financial activities of the user. A financial value is assigned to each of the financial and non-financial activities. A net financial value is determined based on the assigned financial values of each of the financial and non-financial activities, as well as historical net financial values of the user. An alert relating to at least one of the net financial value and the assigned financial values is transmitted to a device of the user.

### CROSS-REFERENCE TO RELATED APPLICATIONS

This application claims priority to U.S. Provisional Patent Application No. 62/246,855 entitled “SYSTEMS AND METHODS FOR QUANTIFYING FINANCIAL HEALTH IMPACT OF LIFE ACTIVITIES,” by Vlatvsky et al., filed on Oct. 27, 2015, which is herein incorporated by reference in its entirety and for all purposes.

### BACKGROUND

The present disclosure relates generally to the field of personal financial management (PFM). More specifically, the present disclosure relates to systems and methods for quantifying the financial health impact of life activities.

Individuals often rely on computer-based systems, such as PFM systems, to manage their personal finances. Conventional PFM systems include software and Internet-based systems. Certain systems allow users to create budgets and to track goals. However, many systems are cumbersome and difficult to use. Furthermore, many users are unable to understand how their day-to-day decisions and life activities affect their financial health.

### SUMMARY

According to an example embodiment, a computer-implemented method includes receiving financial activity information associated with a financial account of a user. The financial activity information relates to one or more financial activities of the user. Non-financial activity information associated with the user is received. The non-financial activity information relates to one or more non-financial activities of the user. A financial value is assigned to each of the financial and non-financial activities. A net financial value is determined based on the assigned financial values of each of the financial and non-financial activities, as well as historical net financial values of the user. An alert relating to at least one of the net financial value and the assigned financial values is transmitted to a device of the user.

According to another example embodiment, a system includes a financial health account associated with a user of the system. The system also includes a server system, including a processor and instructions stored in non-transitory machine-readable media. The instructions are configured to cause the server system to receive financial activity information associated with a financial account of a user. The financial activity information relates to one or more financial activities of the user. Non-financial activity information associated with the user is received. The non-financial activity information relates to one or more non-financial activities of the user. A financial value is assigned to each of the financial and non-financial activities. A net financial value is determined based on the assigned financial values of each of the financial and non-financial activities, as well as historical net financial values of the user. An alert relating to at least one of the net financial value and the assigned financial values is transmitted to a device of the user.

According to another example embodiment, a system includes a financial health account associated with a user of the system. The system also includes a server system including a processor and instructions stored in non-transitory machine-readable media. The instructions are configured to cause the server system to establish operative communication with a smart device of the user. The smart device is configured to measure a non-financial activity of the user. Measured non-financial activity information is received from the smart device. The non-financial activity information relates to a non-financial activity of the user. A cost-savings associated with the non-financial activity is determined. An alert relating to the cost savings is transmitted to a device of the user.

Another example embodiment includes system, including a financial health account associated with a user of the system. The system also includes a server system, including a processor and instructions stored in non-transitory machine-readable media. The instructions are configured to cause the server system to establish operative communication with a smart device of the user. The smart device is configured to measure a non-financial activity of the user. Measured non-financial activity information is received from the smart device. The non-financial activity information relates to a non-financial activity of the user. Financial activity information associated with a financial account of the user is received. The financial activity information relates to financial activities of the user. A risk profile is developed based on the financial and non-financial activity information. The risk profile relates to a propensity of the user to experience an event causing a financial loss to the user. An alert relating to the risk profile is transmitted to a device of the user.

### BRIEF DESCRIPTION OF THE DRAWINGS

The details of one or more implementations are set forth in the accompanying drawings and the description below. Other features, aspects, and advantages of the disclosure will become apparent from the description, the drawings, and the claims.

FIG. 1 is block diagram of a data processing system, according to an embodiment.

FIG. 2 is a block diagram of the financial health computing system of the data processing system of FIG. 1, according to an embodiment.

FIG. 3 is a financial impact interface that may be provided to a user via a device of the user, according to an example embodiment.

FIGS. 4A-4C are flow diagrams illustrating processes for determining the financial impact of life activities, according to various embodiments.

### DETAILED DESCRIPTION

Before turning to the figures which illustrate example embodiments, it should be understood that the application is not limited to the details or methodology set forth in the following description or illustrated in the figures. It should also be understood that the phraseology and terminology employed herein is for the purpose of description only and should not be regarded as limiting.

Individuals' personal finances are often significantly intertwined with decisions—both financial and non-financial—that they make on a daily basis. Most apparently, individuals' decisions to purchase items impact their cash flow. However, such decisions may also have secondary effects. For example, individuals who choose to eat cheeseburgers every day may have a higher risk of heart disease and diabetes, which may affect their life expectancy. In turn, their life expectancy may affect their earning potential and/or retirement needs.

Various types of systems, such as PFM systems, have been developed to attempt to make it easier for individuals to manage their money. For example, some PFM systems facilitate categorizing transactions into various budget categories. The categorized data may be used to display spending trends, budgets, and net worth, for example. Although, PFM systems assist users in identifying their past and current financial health, such systems fail to provide a holistic view of how individuals' life decisions impact their overall financial health, considering both primary and secondary effects that the decisions may have on the individuals' personal finances.

Referring generally to the figures, systems and methods for determining the financial impact of financial and non-financial activities are shown. In particular, the figures include a financial health computing system configured to monitor various financial and non-financial activities over time. The financial and non-financial activities may be monitored via operative communication with various connected systems, devices, and accounts. For example, financial activities may be monitored via operative communication with a financial institution (FI) computing system to receive, for example, a user's financial transaction information. As another example, non-financial activities may be monitored via operative communication with a user's smart devices (e.g., smartphone, wearable devices, etc.), connected vehicle, or other third-party accounts to monitor the user's physical activity, location, operational patterns, etc. In some embodiments, financial values may be assigned to each of the monitored financial and non-financial activities. A net financial value may be calculated based on the assigned financial values, as well as historical net financial values of the user. In other embodiments, cost-savings associated with the monitored financial and non-financial activities, relative to baseline expected values, is calculated. In further embodiments, a risk profile is developed based on the monitored financial and non-financial activities. The risk profile may relate to a propensity of the user to experience an event causing a financial loss to the user.

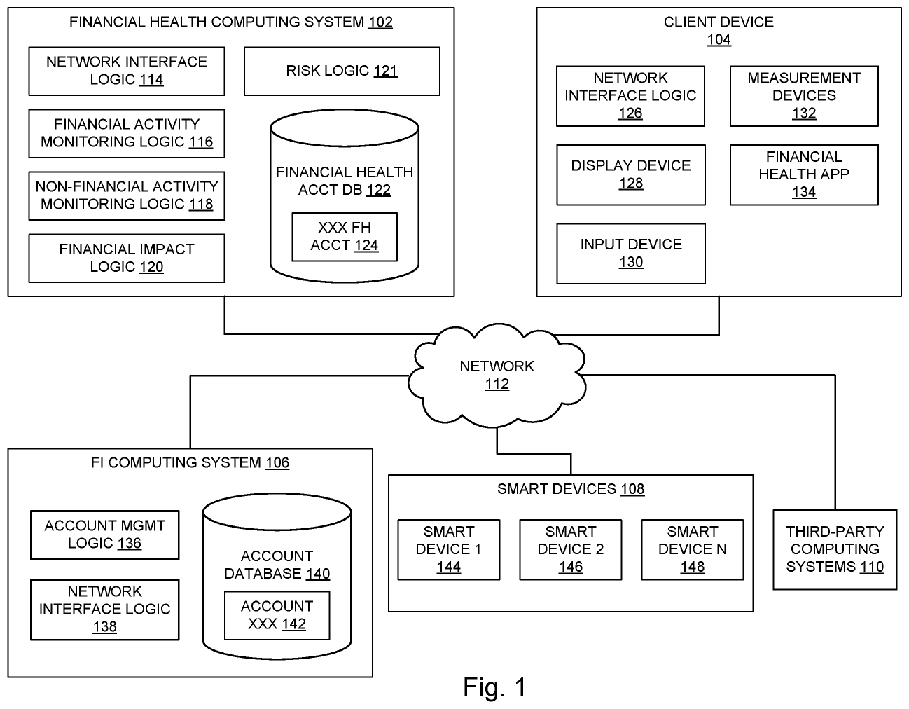

Turning to FIG. 1, a block diagram of a data processing system 100 is illustrated, according to an embodiment. The data processing system 100 may be used to conduct and track both financial and non-financial activities, and to analyze the financial impact of those activities. According to an embodiment, the data processing system 100 includes, among other systems and devices, a financial health computing system 102, a client device 104, a financial institution (FI) computing system 106, one or more smart devices 108, and third-party computing systems 110. The various systems may communicate through a network 112, which may include one or more of the Internet, cellular network, Wi-Fi, Wi-Max, a proprietary banking network, or any other type of wired or wireless network. In some embodiments, the financial health computing system 102 and the FI computing system 106 may be owned by the same entity. In other embodiments, the financial health computing system 102 and the FI computing system 106 may be owned by different entities.

The financial health computing system 102 and the FI computing system 106 may each include a computer system (e.g., one or more servers each with one or more processing circuits), each including a processor and memory. The processors may be implemented as application specific integrated circuits (ASICs), one or more field programmable gate arrays (FPGAs), a group of processing components, or other suitable electronic processing components. The memory may be one or more devices (e.g., RAM, ROM, Flash memory, hard disk storage, etc.) for storing data and/or computer code for completing and/or facilitating the various processes described herein. The memory may be or include non-transient volatile memory, non-volatile memory, and non-transitory computer storage media. The memory may include data base components, object code components, script components, or any other type of information structure for supporting the various activities and information structures described herein. The memory may be communicably connected to the processor and include computer code or instructions for executing one or more processes described herein. The financial health computing system 102 and the FI computing system 106 may each include server-based computing systems, for example, comprising one or more networked computer servers that are programmed to perform the operations described herein. The financial health computing system 102 and the FI computing system 106 may each be implemented as distributed computer systems where each function is spread over multiple computer systems.

In general, the financial health computing system 102 is configured to monitor users' financial and non-financial activities, and to determine the financial impact of those activities. The financial health computing system includes, among other systems and logics, network interface logic 114, financial activity monitoring logic 116, non-financial activity monitoring logic 118, financial impact logic 120, risk logic 121, and a financial health account database 122. The financial health computing system 102 is configured to store and process information regarding financial health accounts. By way of example, information for a specific financial health account 124 is shown as being stored in the financial health account database 122. As will be appreciated, the financial health account database 122 may also store information regarding many other financial health accounts (not shown) for other users.

The network interface logic 114 may include, for example, program logic that connects the financial health computing system 102 to the network 112 to provide operative communication with any of the client device 104, the FI computing system 106, the smart devices 108, and the third-party computing systems 110. Upon creating the financial health account 124, the user may link various sources to the financial health account 124. The linked sources may include accounts and devices, which may be financial and/or non-financial in nature. In the embodiment depicted in FIG. 1, sources may be linked from any of the client device 104, the FI computing system 106, the smart devices 108, and the third-party computing systems 110, among other accounts, devices, or systems. For example, an account (e.g., a bank account) may be linked to the user's financial health account 124 by selecting the account provider (e.g., the banking entity that manages the FI computing system 106) and entering the user's username and password for that account. In another example, a device may be linked to the user's financial health account 124 by binding or registering the device with the user's financial health account 124.

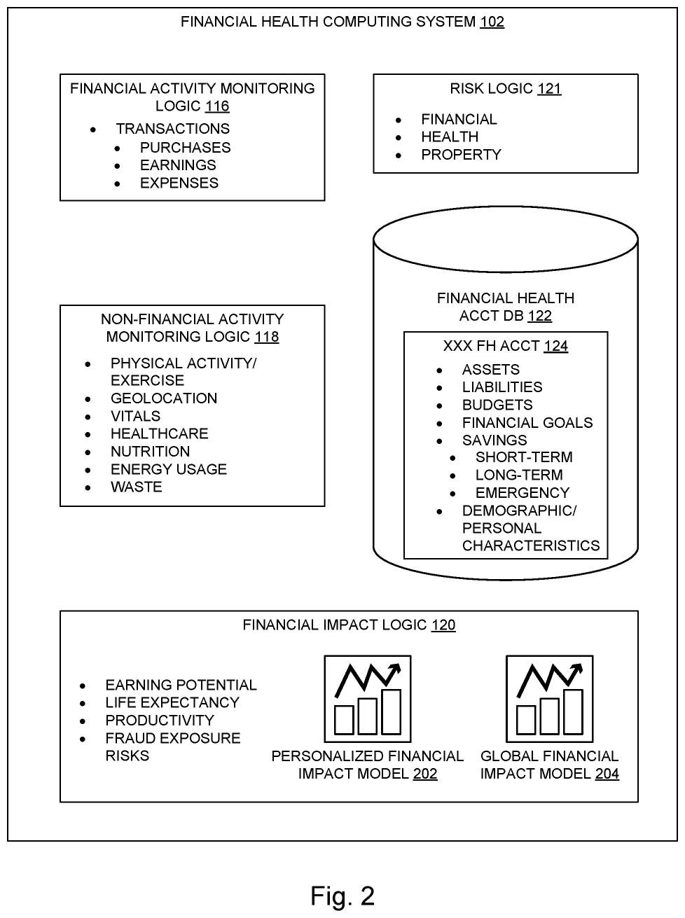

The financial and non-financial activity monitoring logics 116, 118 are configured to monitor the financial and non-financial activity, respectively, received from the connected sources. Activity data may be received in real-time or near real-time once it is generated, or may be received as an aggregated amount via a periodic batch receive process. Activity data may be stored locally in the financial health account database 122 or remotely in a cloud-based database. As will also be appreciated, the extent to which financial and non-financial activity details are tracked and maintained by the financial and non-financial activity monitoring logics 116, 118 and stored in the financial health account database 122 or another database may vary in differing embodiments, and may be controllable by the user. The financial impact logic 120 is configured to determine the financial impact of the activity data received by the financial and non-financial activity monitoring logics 116, 118. This aspect is discussed further in connection with FIG. 2. As will be appreciated, the financial impact of the user's financial and non-financial activities may be utilized in various ways. For example, the user may receive notifications, rewards, offers, recommendations, etc. related to the financial impact. In addition, various actions may be taken based on the financial impact, such as automated savings, for example.

The financial impact logic 120 is structured to determine the financial impact of multiple different financial and non-financial activities, such that a user is able to monitor the financial impacts of multiple activities in one place. Therefore, the financial impact logic 120 provides a global view of the financial impacts of several different behaviors in one location. Accordingly, users can easily determine the financial impact of changing certain behaviors. To this end, the financial impact logic 120 enables users to identify the “low hanging fruit,” or in other words, the activities for which a relatively small change in activity produces a relatively large financial impact. This in itself may incentivize users to change their behaviors. However, in some embodiments, the financial impact logic 120 may also provide further incentives (e.g., offers or discounts) to further encourage users to change their behavior in a certain manner. Further, the financial impact logic 120 may be structured to provide alerts to a user if the user's behavior causes financial impacts that are uncharacteristic relative to the user's typical activities.

The risk logic 121 is configured to analyze various types of risks according to the monitored financial and non-financial activities of a user. Risks may include financial risks (e.g., financial health, fraud, etc.), health risks, property (e.g., vehicle or home) risks, etc. In some implementations, risks may be defined as events that cause the user to experience a financial loss. Risks may be analyzed by the user or by connected third-party computing systems 110. For example, the connected third-party computing systems 110 may include insurance (e.g., health, vehicle, homeowners, etc.) providers. Insurance providers may leverage the vast amount of financial and non-financial data that is being collected about the user to provide more accurate actuarial calculations to improve loss risk predictions. Accordingly, by improving loss risk predictions, insurance providers may offer rates that are the most fair for individual users. In some embodiments, the user's financial health account 124 includes one or more risk profiles. The risk profiles may relate to a propensity of the user to experience an event causing a financial loss to the user, based on the user's financial and non-financial activities. For example, the user's financial health profile may relate to the propensity for the user to experience a physically or mentally debilitating event that requires healthcare service.

The client device 104 may be used by an individual user to create and interact with a financial health account managed by the financial health computing system 102. The client device 104 may, for example, be a cellular phone, smart phone, tablet computer, laptop computer, desktop computer, mobile handheld wireless e-mail device, personal digital assistant, portable gaming device, or other suitable device. The client device 104 includes network interface logic 126, a display device 128, an input device 130, one or more measurement devices 132, and a financial health application (app) 134. The network interface logic 126 may include, for example, program logic that connects the client device 104 to the network 112. For example, the client device 104 may receive and display screens including financial and non-financial activity information, financial impact information, financial and non-financial recommendations, offers, and so on. In one embodiment, a screen may be used to request a username and password information from the user, or to prompt the user to provide information regarding received data that was not automatically categorized. Such screens are presented to the user via the display device 128. The input device 130 may be used to permit the user to initiate account access and to facilitate receiving requested information from the user. The input device 130 may include, for example, a keypad or keyboard, a touchscreen, a microphone, or any other device that allows the user to access the data processing system 100. As will be appreciated, in addition to or instead of the client device 104, users may also be provided with the ability to access the data processing system 100 using another type of computer (e.g., a desktop or laptop computer executing browser software) to perform the operations described herein as being performed by the client device 104. The measurement devices 132 may include any of various types of sensors configured to measure location, position, acceleration, temperature, etc.

The financial health application 134 or financial health circuit may include program logic executable by the client device 104 to implement at least some of the functions described herein. In order to make the financial health circuit 134, the financial health computing system 102 may provide a software application and make the software application available to be placed on the client device 104. For example, the financial health computing system 102 may make the software application available to be downloaded (e.g., via the website of the financial health computing system 102, via an app store, or in another manner). Responsive to a user selection of an appropriate link, the financial health application 134 may be transmitted to the client device 104 and may cause itself to be installed on the client device 104. Installation of the software application creates the financial health circuit on the client device 104. Specifically, after installation, the thus-modified client device 104 includes the financial health circuit (embodied as a processor and instructions stored in non-transitory memory that are executed by the processor).

The FI computing system 106 includes, among other systems and logics, account management logic 136, network interface logic 138, and an account database 140. The account management logic 136 may interact with various backend systems in connection with maintaining financial accounts (e.g., business or consumer demand deposit, credit card, debit card, lines of credit, brokerage accounts, etc.) for account owners. Account information may be stored in the account database 140. By way of example, information for a specific financial account 142 is shown as being stored in the account database 140. As will be appreciated, the account database 140 may also store information regarding many other financial accounts (not shown). The network interface logic 138 may include, for example, program logic that connects the FI computing system 106 to the network 112 to provide operative communication with any of the client device 104, the FI computing system 106, the smart devices 108, and the third-party computing systems 110. For example, the network interface logic 138 may be used to permit users to access the FI computing system 106, for example, through an online banking website or other website, through an application, through a display on a client device 104, or in other ways.

The smart devices 108 may include any number of devices. As illustrated in FIG. 1, the data processing system 100 includes several devices, including a first device 144, a second device 146, and so on, up to an Nth device 148. The smart devices 108 may include any object (e.g., an appliance, a sensor, etc.) that has an addressable interface (e.g., an Internet protocol (IP) address, a Bluetooth identifier (ID), a near-field communication (NFC) ID, etc.) and can transmit information to one or more other devices over a wired or wireless connection. The smart devices 108 may have a passive communication interface, such as a quick response (QR) code, a radio-frequency identification (RFID) tag, an NFC tag, etc., or an active communication interface, such as a modem, a transceiver, etc. The smart devices 108 may be configured to measure any of various types of financial and/or non-financial activities. Accordingly, the smart devices 108 can have a particular set of attributes (e.g., a device state or status) that can be embedded in and/or controlled/monitored by a central processing unit (CPU), microprocessor, application specific integrated circuit (ASIC), etc., and configured for connection to the network 112.

The smart devices 108 may be categorized or grouped in different ways. In one aspect, the smart devices 108 may include personal/wearable devices, home/work devices, and vehicles. personal/wearable devices may be configured to track various aspects of users' activities, such as location, movement, pulse, body temperature, blood pressure, respiratory rate, calorie intake, etc. The personal/wearable devices may include, for example, smart watches, smart glasses, smartphones, activity trackers, clothing or shoes with embedded sensors, portable medical devices, etc.

Home/work devices may be configured to track various parameters of a users' environment, energy usage, product usage, etc. The home/work devices may include, for example, heating, ventilation, and air conditioning (HVAC) systems (e.g., thermostats, air conditioners, furnaces, etc.); utility (e.g., electricity, natural gas, water, etc.) meters; lighting systems; security systems; appliances (e.g., refrigerators, toasters, ovens, microwaves, freezers, dishwashers, clothes washers, clothes dryers, vacuum cleaners, hand tools, etc.); health/exercise equipment (e.g., treadmills, elliptical machines, scales, etc.); entertainment devices (e.g., home theater systems, stereos, televisions, gaming systems, etc.); etc.

Vehicles may include cars, trucks, motorcycles, bicycles, etc., that are capable of transmitting information over a wired or wireless connection. For example, vehicles may transmit information over a cellular or WIFI network via a telematics control module. In another example, vehicles may transmit information via operative communication with another device, such as a user's smartphone. Vehicles may track various types of information, such as location, speed, distance, driving style, driving habits, fuel consumption, etc. In some aspects, personal computing devices such as smartphones, smart phones, cellular phones, desktop computers, laptop computers, tablet computers, etc. may be configured to perform the functionality of any of the personal/wearable devices, home/work devices, or vehicles.

Third-party computing systems 110 may include any of various types of systems configured to measure financial and/or non-financial activities. For example, the third-party computing systems 110 may include FI computing systems other than the FI computing system 106. For example, a user may have additional financial accounts that are managed by a different FI than the FI that manages the FI computing system 106. The third-party computing systems may also include insurance (e.g., health, property, etc.) provider computing systems, utility (e.g., electricity, natural gas, mobile telephone, Internet, etc.) computing systems, merchant computing systems, etc. Third-party computing systems 110 may also include various types of systems that are configured to receive measured financial and non-financial activity information, and to perform calculations on that information.

Turning to FIG. 2, a block diagram of the financial health computing system 102 of FIG. 1 is illustrated, according to an embodiment. FIG. 2 illustrates several examples of parameters utilized in each of the financial and non-financial activity monitoring logics 116, the financial impact logic 120, the risk logic 121, and the financial health account database 122, including the specific financial health account 124. To use the financial health computing system, a user must first establish the user's financial health account 124 via an on-boarding/registration process and link various accounts and devices to the user's financial health account. The user's financial health account 124 provides a baseline upon which financial impact calculations may be based. Over time, financial impact calculations may be stored in the financial health account 124 and compared to users' actual financial performance to refine models and calculations. As shown in FIG. 2, the financial health account 124 may include various financial and non-financial characteristics of users, such as assets, liabilities, budgets, financial goals, savings (e.g., short-term, long-term, and emergency savings, etc.), and demographic or personal characteristics. The financial and non-financial characteristics of the user may be entered automatically (e.g., upon linking one or more accounts) or may be entered manually. For example, in one embodiment, a user links his or her financial (e.g., banking) account 142 (FIG. 1) with the financial health computing system 102. Upon linking the financial account, the financial health computing system 102 may automatically populate the various fields of the user's financial health account 124 based on data pulled from the user's financial account 142. In some embodiments, the user may enter supplemental information in addition to automatically-imported information.

The financial activity monitoring logic 116 is configured to receive any of various types of information that directly relates to the user's finances. For example, the financial activity monitoring logic 116 may monitor transactions, such as purchases, earnings, expenses, etc. The financial activity monitoring logic 116 may receive financial activity information from various sources, such as connected financial accounts (e.g., the financial account 142 of the FI computing system 106) or mobile wallet accounts, for example.

The non-financial activity monitoring logic 118 is configured to receive various types of information that does not directly relate to the user's finances, but that may indirectly impact the user's finances. For example, monitored non-financial activity may include physical activity/exercise, geolocation, vitals, healthcare, nutrition, energy usage, and waste. The specific non-financial information that is captured, and the sources from which it is captured, may be user-defined and managed, and stored in the user's financial health account 124.

The non-financial activity monitoring logic 118 may receive the non-financial information from various connected physical and virtual devices or accounts. For example, physical activity and exercise information may be captured by a wearable device (e.g., an activity tracker, pedometer, smart watch, etc.), a smartphone, a connected gym account, etc. Geolocation may be captured by a location sensor on a smartphone, wearable device, connected car, etc. Geolocation may also be captured by transaction information, such as the location of point-of-sale (POS) devices from which purchases are conducted, based on the location of transit or toll transactions, and so on. To that end, the non-financial activity monitoring logic 118 may receive activity information from the financial activity monitoring logic 116. Vitals (e.g., pulse, body temperature, blood pressure, respiratory rate, etc.) may be captured by wearable devices, medical equipment, etc. Healthcare information may be received from connected electronic medical or prescription records, connected healthcare providers, or may be determined from financial transaction information, etc. Nutrition information may be received from nutrition tracking systems, connected merchants (e.g., restaurants or grocery stores), smart appliances (e.g., refrigerator, scale, etc.), determined from financial transaction information, etc. Energy usage information may be received from connected utility (e.g., electricity, natural gas, etc.) accounts, smart appliances (e.g., power meters, thermostats, etc.), connected vehicles, or determined from financial transaction information (e.g., gas station purchases). Waste may be determined based on any of the other captured information (e.g., by comparing the thermostat set point versus the user's geolocation or by comparing the amount of food purchased versus consumed), from connected appliances (e.g., a smart refrigerator tracking food expiration dates), from financial transactions, etc.

The financial impact logic 120 is configured to assign a financial value to each of the financial and non-financial activities defined by the information received from the financial and non-financial activity monitoring logics 116, 118. The financial impact logic 120 includes a personalized financial impact model 202 and a global financial impact model 204. The personal financial impact model 202 is structured to analyze the financial impact of financial and non-financial activities for a particular user. For example, the personal financial impact model 202 may analyze a user's past financial and non-financial activity information to identify patterns and trends, and to establish baseline financial and non-financial usage characteristics based on the user's past financial and non-financial activity information. In some implementations, the financial impact of financial and non-financial activities is calculated based on the baseline financial and non-financial usage characteristics. For example, the financial impact may relate to a cost savings resulting from the financial or non-financial activities, relative to the baseline. Over time, the personal financial impact model 202 may compare financial values assigned to financial and non-financial activities to the actual impact of the activities to refine the model.

The global financial impact model 204 is structured to analyze the financial impact of financial and non-financial activities of various other users. Furthermore, the global financial impact model 204 may be used in conjunction with the personal financial impact model 202. For example, the personal financial impact model 202 may analyze historical financial impact results of users with similar characteristics (e.g., demographics, income, age, spending patterns, etc.) to predict the financial impact of financial and non-financial activities of a particular user.

In an example embodiment, the global financial impact model 204 is structured to analyze transaction data for multiple customers and to perform a cluster analysis on the data. The cluster analysis may group customers based common transaction patterns into customer segments. This can be done, for example, through the use of a process known as k-means clustering (“KMC”). KMC is a procedure for partitioning data into a defined number of clusters, wherein a given data point is partitioned to the cluster with the closest “mean” value to the data point. As such, the makeup of each data point in a given cluster influences the value (i.e., the mean) of that cluster. In the context of financial and non-financial activity data, KMC can partition pattern data sets into clusters with a “mean” pattern for each cluster (e.g., a collective pattern shape, or an average of SAX-derived character strings), with the “mean” pattern being a pattern arising from the average shape of the financial and non-financial activity patterns associated with a given cluster.

Each of the personalized and global financial impact models 202, 204 are configured to analyze financial impact with regard to various parameters, such as cash flow, product costs, usage costs, potential substitutes, earning potential, life expectancy, productivity, fraud exposure risks, etc. Each of these factors may affect the financial performance of an individual. In addition to identifying patterns and correlations from other similarly-positioned users, the personal and global financial impact models 202, 204 may also employ various financial and non-financial models to take into account various short-term and long-term financial parameters, such as product or service costs, interest rates, inflation rates, taxes, earnings potential, expenses, etc.

In some example embodiments, the personalized and global financial impact models 202, 204 are each programmed with certain logic configured to analyze financial impacts. The logic may include formulas that have been determined or proven through research or other means and manually programmed into the models. For example, certain studies may have identified that exercising four times per week saves a certain percentage of healthcare costs. Accordingly, the personal and global financial impact models 202, 204 may include logic programmed to calculate savings based on such parameters.

The personal and global financial impact models 202, 204 may calculate financial impacts based on a wide range of user activities or behaviors. For example, the personal financial impact model 202 may establish average spending rates for various categories, such as groceries, restaurants, clothing, transportation, travel, bills (e.g., phone, Internet, utilities, etc.). If a user dines at a particularly expensive restaurant, that activity may have a significant financial impact on the user's typical restaurant spend.

In another example, if a user orders fast food several times per week (e.g., as indicated by the user's financial transaction information), the user may be less productive at work, thereby affecting the user ability to advance and potentially earn more money. The user's life expectancy may also be shortened, thereby affecting the user's earning potential. However, a lower life expectancy may also reduce the amount needed to save for retirement.

In another example, a wearable device or activity tracker may indicate that a user is frequently stressed (e.g., via pulse or blood pressure measurements). Therefore, the user may have a shorter life expectancy or may have a higher propensity to make poor financial decisions. Alternatively, a wearable device or activity tracker may indicate that a user exercises frequently, which may indicate that the user may have a longer life expectancy, higher earning potential, and a propensity to make better financial decisions.

In another example, a user may have the option to drive, walk, take a taxi, or take public transportation to get to work. The financial activity monitoring logic may receive transaction information indicating if the user takes a taxi or public transportation. The user's vehicle may provide operational information indicating usage of the vehicle, as well as the vehicle's route. The user's smartphone may track the user's route and speed to indicate whether the user walked or took another form of transportation. Further yet, step measurements and heartrate from the user's activity monitor or smart watch may indicate whether the user walks. Walking or taking public transportation may provide a positive financial impact to the user, and driving or taking a taxi may provide a negative financial impact to the user.

In some example embodiments, the personalized and global financial impact models 202, 204 include machine learning and data mining algorithms to analyze various users' behaviors, and to correlate those behaviors with their corresponding financial impacts. Accordingly, the personalized and global financial impact models 202, 204 may build complex models over time using anonymized data in order to provide extremely accurate predictions based on any of various factors. Such analysis may involve grouping individuals in clusters, as discussed above.

In one example, the financial impact logic 120, based on analysis from the personal and global financial impact models 202, 204, may suggest activities to cause a user to behave more like users in more desirable clusters or cohorts. For example, first and second users may have similar salaries and expenses, but the second user may have a much better credit score. Accordingly, the personal and global financial impact models 202, 204 may identify certain behaviors of the second user that may affect the user's credit score, and may suggest such behaviors to the first user. In another example, the personal and global financial impact models 202, 204 may identify that if the first user engaged in certain activities that the second user regularly engages in, the first user could save a certain amount of money per month.

The financial impact logic 120 may provide financial impact results to users in various ways. For example, the financial impact logic 120 may provide notifications to users about activities that have a financial impact above a threshold level, or activities that have the top five financial impact levels for the user, for example. Alternatively, the financial impact logic 120 may notify users about activities that have a financial impact that is relatively high compared to other similar users.

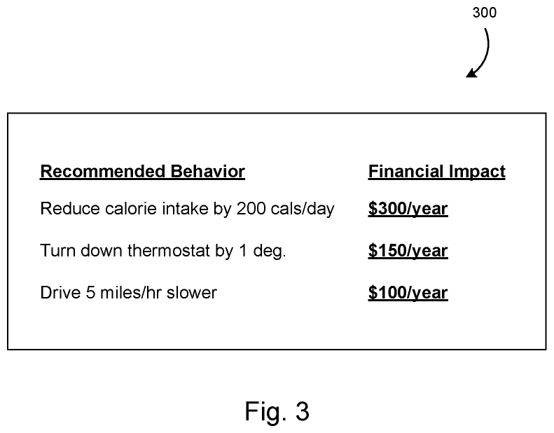

FIG. 3 is a financial impact interface 300 that may be provided to a user via a device (e.g., the client device 104, such as a smartphone or mobile computing device, for example), according to an example embodiment. As shown in FIG. 3, the financial impact logic 120, based on analysis from the personal and global financial impact models 202, 204, may identify recommend behavioral changes for a user, with an estimated cost savings associated with each recommended behavioral change. For example, as shown in FIG. 3, a first recommended behavior is “reduce calorie intake by 200 calories/day,” and the associated financial impact is a savings of $300/year. This may be calculated, for example, based on both healthcare and food cost savings, among other factors. A second recommended behavior is “turn down thermostat by 1 degree,” and the associated financial impact is $150/year. This may be calculated, for example, based on projected energy savings. A third recommended behavior is “drive 5 miles/hour slower,” and the associated financial impact is $100/year. This may be calculated, for example, based on projected fuel economy savings and speeding ticket avoidance, for example.

The financial impact logic 120 may also allow the user to automatically implement the suggestions (e.g., via a smart thermostat), and may interface with the FI computing system 106 to automatically transfer the savings to the user's financial account 142 (e.g., savings account). Furthermore, through operative communication with the user's financial account 142, the financial impact logic 120 can provide recommendations that are particularly relevant to the user. For example, a user may have an emergency savings goal defined in connection with the user's financial account 142. The non-financial activity logic 118, via the user's connected refrigerator, may identify that the user typically purchases a gallon of milk, and it consistently expires before the user consumes it. Accordingly, the next time that the user is shopping for groceries, the financial impact logic 120 may recommend that the user purchases a half gallon of milk, and may allow the user to automatically allocate the corresponding savings to the user's emergency savings account. In other examples, the third-party computing systems 110 may include merchants or other companies that offer coupons or loyalty programs. The financial impact logic 120, via operative communication with the FI computing system 106, may facilitate automatic deposits of savings into the user's financial account 142. The FI computing system 106 may also provide the user rewards or cash back based on the user's activities.

In some embodiments, the financial impact logic 120 may provide rewards, offers, or other incentives to encourage the user to engage in certain behavior. The rewards may include cash rewards, rewards points, airline miles, discounts, etc. FIs or other third-parties may want to incentivize certain user behavior that mutually beneficial to both the user and the FI or other parties. For example, an FI may want to ensure that a customer has a certain amount of cash in his or her DDA account in order to ensure that the customer is able to make payments on a mortgage that is also held by the FI. To this end, the FI may provide certain incentives to encourage the user to engage in financially healthy behavior. In another example, the financial impact logic 120 may identify that a user does not exercise regularly, and accordingly, may be more likely to have certain health issues, which will drive up the user's healthcare costs. Therefore, the financial impact logic 120 may provide offers from certain gyms or health clubs for reduced membership fees.

The risk logic 121 is configured to analyze various types of risks according to the monitored financial and non-financial activities of a user. In some embodiments, the risk logic 121 develops one or more risk profiles for a user, which are stored in the user's financial health account 124. Risks may include financial risks (e.g., financial health, fraud, etc.), health risks, property (e.g., vehicle or home) risks, etc. The risk logic 121 may provide risk data to third-party computing systems 110, such as insurance providers or FIs. For example, insurance providers may provide reduced rates for low-risk or risk-reducing activities. As another example, FIs may also provide rewards or reduced rates, or may base loan approval on risks analyzed by the risk logic 121, because a user is more likely to be able to reliably make payments if other major financial obligations (e.g., a new car, major healthcare operations, home repair, etc.) are avoided.

For example, the non-financial activity monitoring logic 118 may monitor driving habits of a user, such as miles traveled, geographic locations traveled, average speed, top speed, vehicle acceleration, impact measurements, seat belt use, etc. The risk logic 121 may predict the risk that the user will have an accident in the future. The risk logic 121 may provide risk information or raw data to third-party computing systems 110, such as the user's vehicle insurance company. Accordingly, the vehicle insurance company may provide the user a discounted rate for low risk driving. Additionally or alternatively, the risk logic 121 may provide the user recommendations to change his or her driving style to reduce vehicle accident risks.

In another example, the financial and/or non-financial activity monitoring logic 116, 118 may receive information relating to a user's health based on, for example, transaction information (e.g., medical provider payments, food purchases), quantified self measurements (e.g., activity information, workout logs, vitals measurements), electronic medical records (e.g., indicating preventative care activities), etc. Based on the monitored activity information, the risk logic 121 may predict the risk that the user will have certain health issues in the future. The risk logic 121 may provide the risk information or the raw data to third-party computing systems 110, such as the user's health insurance company. Accordingly, the health insurance company may provide the user a discounted rate for engaging in healthy lifestyle activities. Additionally or alternatively, the risk logic 121 may provide the user recommendations to perform certain actions or change certain behaviors to improve his or her physical health, which may secondarily affect the user's financial health.

In a further example, the financial and/or non-financial activity monitoring logic 116, 118 may receive information relating to a user's home maintenance based on, for example, transaction information (e.g., payments to contractors or merchants), measurements from smart devices 108 (e.g., maintenance logs and energy usage), etc. Based on the monitored activity information, the risk logic 121 may predict the risk that the user's home will have certain issues in the future. For example, the user may have recently upgraded the sump pump, thereby reducing the risk of basement flooding. The risk logic 121 may provide the risk information or the raw data to third-party computing systems 110, such as the user's homeowner's insurance company. Accordingly, the homeowner's insurance company may provide the user a discounted rate for the user's homeowner's insurance due to the user's risk-lowering activities. Additionally or alternatively, the risk logic 121 may provide the user recommendations to perform certain actions or change certain behaviors to decrease the risk of the user's home becoming damaged.

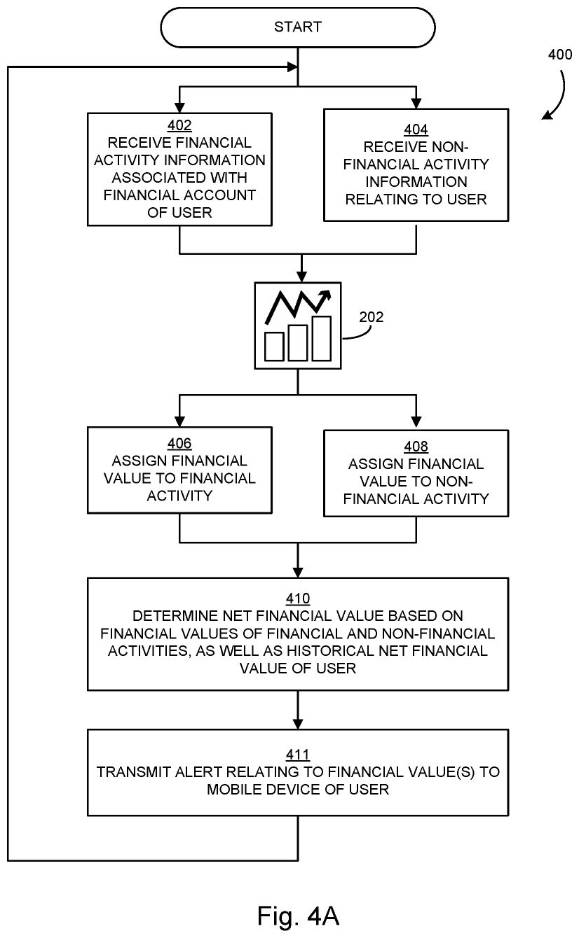

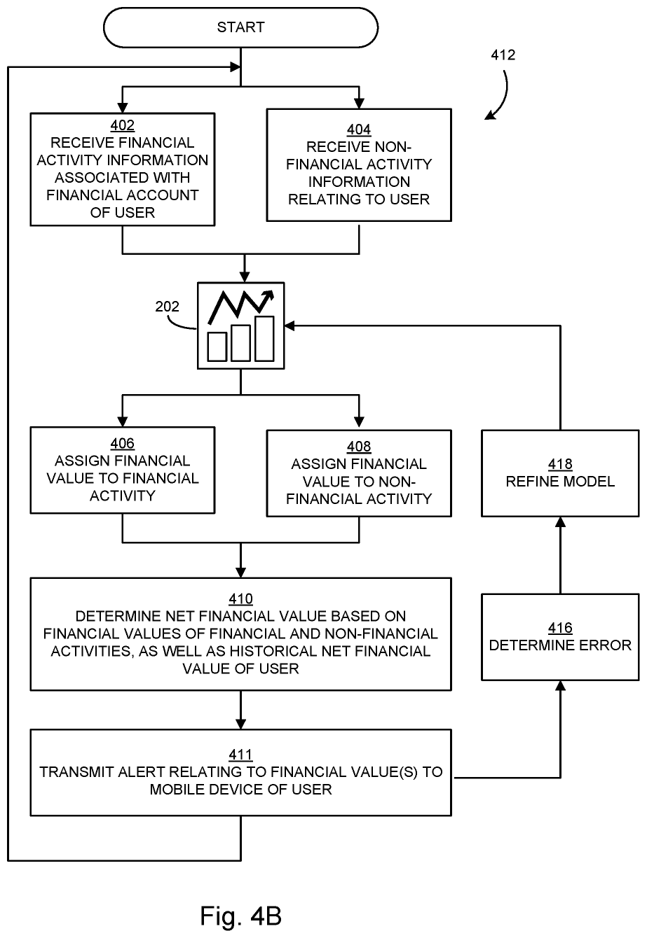

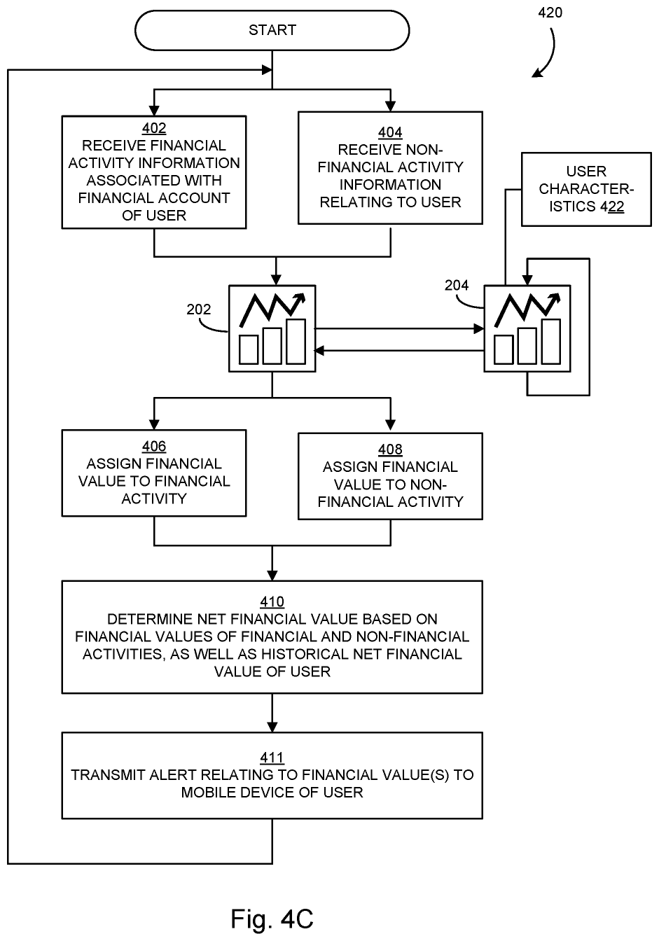

FIG. 4A is a flow diagram illustrating a process 400 for determining the financial impact of life activities, according to an embodiment. In one embodiment, the process 400 is performed by the financial health computing system 102 of FIGS. 1 and 2. However, in other embodiments, the process 400 may be performed by other systems or devices.

At 402, financial activity information associated with a financial account of a user is received by the financial activity monitoring logic 116. The financial activity information relates to one or more financial activities of the user. For example, the financial activity may include financial transaction records received from the user's financial account 142 via the FI computing system 106. The financial transaction records may already be categorized by the FI computing system 106 according to product or merchant categories, or the financial activity monitoring logic 116 may be configured to categorize the transactions.

At 404, non-financial activity information relating to the user is received by the non-financial activity monitoring logic 118. The non-financial activity information relates to one or more non-financial activities of the user. For example, non-financial activity information may include physical activity/exercise information from connected smart devices 108, such as activity trackers or smart watches. As another example, non-financial activity information may include product usage and waste, as determined by connected smart devices 108, such as smart appliances.

The financial and non-financial activity information received at 402 and 404 is analyzed by the personal financial impact logic 202. At 406, financial values are assigned to the financial activities received at 402. At 408, financial values are assigned to the non-financial activities received at 404. For example, financial values may be assigned to financial and non-financial activities based on a prediction of the impact that the activities will have on the user's cash flow. Depending on the activity, the activity may have short-term and/or long-term financial impacts. According to an embodiment, predicting financial impact may involve analyzing at least one of earning potential and life expectancy of the user. For example, analyzing earning potential may involve analyzing the impact that an activity has on the productivity of the user.

At 410, a net financial value is determined based on the assigned financial values of each of the financial and non-financial activities assigned at 406 and 408, as well as a historical net financial value of the user. The net financial value may be determined with regard to monitored baseline values. Historical data may be measured over time to define a user's typical activity. For example, a user may turn down the thermostat every night and every day when he or she goes to work. Therefore, monitoring that the user turns down the thermostat the typical amount will not result in a cost savings. However, if the user does not regularly turn down the thermostat, monitoring that the user turns down the thermostat might result in a cost savings. During the initial use period, the net financial value may be estimated based on average values retrieved from the global financial impact model 204. However, as activities are monitored over time, the personal financial model 202 will become more and more accurate.

The net financial value may include a calculation involving similar activities over a period of time. For example, the net financial value may specify that a user may save $100 per month by making coffee at home instead of buying coffee from a merchant. The net financial value may also be expressed in terms of the impact that the assigned financial values has on the user's account balances. For example, the net financial value may specify that exercising three times per week is likely to save the user $200,000 over the user's lifetime due to lower healthcare costs and higher earning potential.

At 411, an alert relating to at least one of the assigned financial values and the net financial value is transmitted to a device of the user. The alert activates an application so as to cause the application to display the received assigned financial values and/or net financial value. In one example embodiment, the alert includes recommended activities and estimated cost savings associated with the recommended activities. In another example embodiment, the alert includes recommended activities and rewards or offers associated with the recommended activities.

FIG. 4B is a flow diagram illustrating a process 412 for determining the financial impact of life activities, according to an embodiment. The process 412 of FIG. 3B is an alternative embodiment of the process 400 of FIG. 4A. In particular, the process 412 is similar to the process 400, except that the process 412 includes additional steps relating to improving and refining the personal financial impact model 202. Steps 402-410 may be performed in a generally similar manner in any of the processes 400, 412, and 420 of FIGS. 4A-4C.

Referring to FIG. 4B, at 414, the actual financial impact of each of the financial and non-financial activities assigned at 406 and 408 is monitored. For example, it may have been predicted at 406 that a purchase would have a particular impact on a user's available funds. At 414, the actual financial impact of the financial and non-financial activities is measured. In order for the actual financial impact to be measured, the net financial impact of all of the financial and non-financial activities must be parsed to identify the actual financial impact of individual activities.

At 416, error between the actual financial impact monitored at 414 and the assigned financial values of the financial and non-financial activities (determined at 406 and 408) is calculated. The error may be calculated as the difference between these values. In essence, the error calculated at 416 quantifies the inaccuracy of the personal financial impact model 202.

At 418, the personal financial impact model 202 is refined based on the error calculated at 416. For example, certain assumptions may have to be made in generating the personal financial impact model 202. In actuality, some of these assumptions may be shown to have been improperly defined. Furthermore, the personal financial impact model 202 may assume that the user behaves rationally or otherwise similarly to other users. However, that may not always be the case. Accordingly, the personal financial impact model 202 may be refined overtime based on the actual behavior and response of the user. Over time, the personal financial impact model 202 is expected to become more accurate, thereby resulting in lower and lower error over time.

FIG. 4C is a flow diagram illustrating a process 420 for determining the financial impact of life activities, according to an embodiment. The process 420 of FIG. 4C is an alternative embodiment of the processes 400 and 412 of FIGS. 4A and 4B. In particular, the process 420 is similar to the process 400, except that the process 420 further utilizes the global financial impact model 204. As described in connection with FIG. 2, the global financial impact model 204 is structured to analyze the financial impact of financial and non-financial activities for various other users. As illustrated in FIG. 4C, the personal financial impact model 202 is in operative communication with the global financial impact model 204 to provide enhanced financial impact analysis. According to an embodiment, the global financial impact model 202 receives various user characteristics 422. The user characteristics 422 may relate to the user's demographics, income, age, spending patterns, etc. The global financial impact model 204 analyzes the historical financial impact results of users with similar user characteristics 422, and provides those results to the personal financial impact model 202. The personal financial impact model 202 may use the historical financial impact of other similar users as one factor in assigning financial values to various financial and non-financial activities of the user.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions. Software implementations could be accomplished with standard programming techniques with rule based logic and other logic to accomplish the various connection steps, processing steps, comparison steps and decision steps.

While this specification contains many specific implementation details, these should not be construed as limitations on the scope of what may be claimed, but rather as descriptions of features specific to particular implementations. Certain features described in this specification in the context of separate implementations can also be implemented in combination in a single implementation. Conversely, various features described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated in a single software product or packaged into multiple software products embodied on tangible media.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

The claims should not be read as limited to the described order or elements unless stated to that effect. It should be understood that various changes in form and detail may be made by one of ordinary skill in the art without departing from the spirit and scope of the appended claims. All implementations that come within the spirit and scope of the following claims and equivalents thereto are claimed.

1. A computer-implemented method, comprising:
receiving, by a computer system, financial activity information associated with a financial account of a user, the financial activity information relating to one or more financial activities of the user, wherein the financial activities of the user comprise information regarding transaction information associated with purchases made by the user with third parties;
receiving, by the computer system, non-financial activity information relating to the user, the non-financial activity information relating to one or more non-financial activities of the user, wherein the non-financial activity information comprises physical activity information of the user;
assigning, by the computer system, a financial value to each of the financial and non-financial activities, wherein the assigning the financial value comprises:
accessing, by a processor of the computer system, a personalized financial impact model and a global impact model, wherein the personalized financial impact model and the global impact model comprise correlations between various financial activities and non-financial activities and respective financial impacts, and wherein the global impact model is based on analyzed transactional data of multiple customers having similar demographics to the user; and
determining, by the processor, the financial value of each of the financial and non-financial activities using the personalized financial model and the global impact model;
determining, by the computer system, a net financial value, the net financial value being determined based on the assigned financial values of each of the financial and non-financial activities, as well as historical net financial values of the user; and
transmitting, by the computer system to a device of the user, an alert relating to at least one of the net financial value and the assigned financial values, wherein the alert causes a display on the device to present a graphical user interface that includes an indication of the net financial value, an indication of a specific non-financial activity of the one or more non-financial activities, and an indication of an assigned value of the specific non-financial activity, wherein the indication of the specific non-financial activity comprises an indication of the physical activity of the user, and wherein the indication of the assigned value of the specific non-financial activity indicates a financial impact of the physical activity of the user.

2. The method of claim 1, further comprising determining, by the computer system, a reward based on the assigned financial values, the reward structured to incentivize certain activities of the user, wherein the alert relates to the reward.

3. The method of claim 1,
wherein at least one of the financial and the non-financial values relates to a recurring cost or usage,
wherein the net financial value relates to a cost savings of the recurring cost or usage relative to a historical average of the recurring cost or usage, and
wherein the alert relates to the cost savings.

4. The method of claim 1, wherein assigning a financial value to the non-financial activities further comprises predicting the impact that each of the non-financial activities will have on the user's cash flow.

5. The method of claim 4, wherein the impact includes both short-term and long-term impact.

6. The method of claim 4, wherein predicting the impact includes analyzing at least one of earning potential and life expectancy of the user.

7. The method of claim 6, wherein analyzing earning potential includes analyzing the impact of the non-financial activity on productivity of the user.

8. The method of claim 1, further comprising:
monitoring, by the computer system, the financial impact of each of financial and non-financial activities for a plurality of users over time; and
modeling, by the computer system, the financial impact of each of the financial and non-financial activities of the plurality of users based on characteristics of the plurality of users to create the global financial impact model.

9. The method of claim 1, further comprising:
monitoring, by the computer system, the actual financial impact of each of the financial and non-financial activities;
comparing, by the computer system, the actual financial impact to the assigned financial values to update the personalized financial impact model for the user; and
assigning, by the computer system, a financial value to each of subsequent financial and non-financial activities of the user based on the personalized financial impact model.

10. The method of claim 1, wherein non-financial activity information is received from a wearable device of the user.

11. A system, comprising:
a financial health account associated with a user of the system; and
a server system, the server system comprising a processor and instructions stored in non-transitory machine-readable media, the instructions configured to cause the server system to:
receive financial activity information associated with a financial account of a user, the financial activity information relating to one or more financial activities of the user;
receive non-financial activity information relating to the user, the non-financial activity information relating to one or more non-financial activities of the user, wherein the non-financial activity information comprises physical activity information of the user;
assign a financial value to each of the financial and non-financial activities, wherein assigning the financial value comprises:
accessing, via the processor, a personalized financial impact model and a global impact model, wherein the personalized financial impact model and the global impact model comprise correlations between various financial activities and non-financial activities and respective financial impacts, and wherein the global impact model is based on analyzed transactional data of multiple customers having similar demographics to the user; and
determining, via the processor, the financial value of each of the financial and non-financial activities using the personalized financial model and the global impact model;
determine a net financial value, the net financial value being determined based on the assigned financial values of each of the financial and non-financial activities, as well as historical net financial values of the user; and
transmit, to a device of the user, an alert relating to at least one of the net financial value and the assigned financial values, wherein the alert causes a display on the device to present a graphical user interface that includes an indication of the net financial value, an indication of a specific non-financial activity of the one or more non-financial activities, and an indication of an assigned value of the specific non-financial activity, wherein the indication of the specific non-financial activity comprises an indication of the physical activity of the user, and wherein the indication of the assigned value of the specific non-financial activity indicates a financial impact of the physical activity of the user.

12. The system of claim 11, wherein the instructions are further configured to cause the server system to determine a reward based on the assigned financial values, the reward structured to incentivize certain activities of the user, and wherein the alert relates to the reward.

13. The system of claim 11,
wherein at least one of the financial and the non-financial values relates to a recurring cost or usage,
wherein the net financial value relates to a cost savings of the recurring cost or usage relative to a historical average of the recurring cost or usage, and
wherein the alert relates to the cost savings.

14. The system of claim 11, wherein assigning a financial value to the non-financial activities includes predicting the impact that each of the non-financial activities will have on the user's cash flow.

15. The system of claim 14, wherein the impact includes both short-term and long-term impact.

16. The system of claim 15, wherein predicting the impact includes analyzing at least one of earning potential and life expectancy of the user.

17. The system of claim 16, wherein analyzing earning potential includes analyzing the impact of the non-financial activity on productivity of the user.

18. The system of claim 11, wherein the instructions are further configured to cause the server system to:
monitor the financial impact of each of financial and non-financial activities for a plurality of users over time; and
model the financial impact of each of the financial and non-financial activities of the plurality of users based on characteristics of the plurality of users to create a global financial impact model.

19. The system of claim 11, wherein the instructions are further configured to cause the server system to:
monitor the actual financial impact of each of the financial and non-financial activities;
compare the actual financial impact to the assigned financial values to update the personalized financial impact model for the user; and
assign a financial value to each of subsequent financial and non-financial activities of the user based on the personalized financial impact model.

20. The system of claim 11, wherein non-financial activity information is received from a wearable device of the user.

21. A system, comprising:
a financial health account associated with a user of the system; and
a server system, the server system comprising a processor and instructions stored in non-transitory machine-readable media, the instructions configured to cause the server system to:
establish operative communication with a smart device of the user, the smart device configured to measure non-financial activities of the user;
receive measured non-financial activity information from the smart device, the non-financial activity information relating to a non-financial activity of the user;
determine a cost-savings associated with the non-financial activity, wherein to determine the cost-savings the instructions are further configured to cause the server system to:
access, via the processor, a personalized financial impact model and a global impact model, wherein the personalized financial impact model and the global impact model comprise correlations between various financial activities and non-financial activities and respective financial impacts; and
determine, via the processor, the cost savings of the non-financial activities using the personalized financial model and the global impact model, wherein the global impact model is based on analyzed transactional data of multiple customers having similar demographics to the user; and
transmit, to a device of the user, an alert relating to the cost savings, wherein the alert causes a display on the device to present a graphical user interface that includes an indication of the net financial value, an indication of a specific non-financial activity of the non-financial activities, and an indication of an assigned value of the specific non-financial activity wherein the indication of the specific non-financial activity comprises an indication of the physical activity of the user, and wherein the indication of the assigned value of the specific non-financial activity indicates a financial impact of the physical activity of the user.

22. The system of claim 21, wherein to determine the cost-savings the instructions are further configured to cause the server system to:
establish a first baseline for the non-financial activity using the personalized financial model and the global impact model, the first baseline relating to expected values of the measured non-financial activity information,
wherein the cost-savings is further determined relative to the first baseline.

23. The system of claim 21, wherein the instructions are further configured to cause the server system to:
receive financial activity information from a financial account of the user; and
determine a cost-savings associated with the non-financial activity.

24. The system of claim 23, wherein the instructions are further configured to cause the server system to:
establish a second baseline for the financial activity, the second baseline relating to expected values of the received financial activity information,
wherein the cost-savings is determined relative to the second baseline.

25. (canceled)
